(19) United States
(12) Patent Application Publication
(10) Pub. No.: US 2025/0261702 A1
(43) Pub. Date: Aug. 21, 2025

(54) AEROSOL PROVISION DEVICE WITH FINGERPRINT SCANNER

(71) Applicant: NICOVENTURES TRADING LIMITED, London (GB)

(72) Inventor: Najeeb YOUNOSSI, London (GB)

(21) Appl. No.: 18/858,398

(22) PCT Filed: Apr. 21, 2023
(86) PCT No.: PCT/GB2023/051051

§ 371 Date: Oct. 21, 2024

(30) Foreign Application Priority Data
Apr. 22, 2022 (GB) 2205868.9

(51) Int. Cl. A24F 40/60; A24F 40/40; A24F 40/53; A24F 40/65; G06V 40/13

(52) U.S. Cl. CPC A24F 40/60; A24F 40/40; A24F 40/53; A24F 40/65; G06V 40/13

(57) ABSTRACT

There is provided an aerosol provision device (100), for providing an aerosol for inhalation by a user, comprising: a housing (110) having an outwardly facing surface, the outwardly facing surface having an area; control circuitry (120) for controlling an activation state of the aerosol provision device; and, a fingerprint scanner (130) for detecting fingerprints of users, located on the housing of the aerosol provision device, the fingerprint scanner having at least one region, the fingerprint scanner having a surface, wherein the surface of the fingerprint scanner has an area which is at least 40% of the area of the outwardly facing surface of the housing of the aerosol provision device.

### TECHNICAL FIELD

The present invention relates to an aerosol provision device, a method of providing an aerosol for inhalation by a user, an aerosol provision system and aerosol provision means.

### BACKGROUND

Aerosol provision systems are known. Common systems use heaters which are activated by a user to create an aerosol by an aerosol provision device from an aerosol generating material which is then inhaled by the user. The device may be activated by a user at the push of a button or merely by the act of inhalation. Modern systems can use consumable elements containing the aerosol generating material. It can be desirable for the manufacturer to enable control over the activation of the systems. This may avoid the activation of the system in undesirable circumstances.

The present invention is directed toward solving some of the above problems.

### SUMMARY

Aspects of the invention are defined in the accompanying claims.

In accordance with some embodiments described herein, there is provided an aerosol provision device, for providing an aerosol for inhalation by a user, comprising: a housing having an outwardly facing surface, the outwardly facing surface having an area; control circuitry for controlling an activation state of the aerosol provision device; and, a fingerprint scanner for detecting fingerprints of users, located on the housing of the aerosol provision device, the fingerprint scanner having at least one region, the fingerprint scanner having a surface, wherein the surface of the fingerprint scanner has an area which is at least 40% of the area of the outwardly facing surface of the housing of the aerosol provision device.

Such an arrangement is able to identify a potential user of the aerosol provision device and allow authorised users to operate the device. In particular, the arrangement detects fingerprints of a potential user and changes an activation state of the aerosol provision device accordingly.

The aerosol provision device of the present invention is able to operate in “offline” or “online” mode when identifying potential users. In this way, a valid user may operate the device in offline environment provided the user satisfies the criteria for operation. The user experience of the device is thereby improved.

The arrangement is also able to provide a “plug-and-play” approach. In that, the user may pre-program the device to recognise their fingerprints. Prior to subsequent use sessions, as the user touches the device and moves the device towards their mouth, the device may recognise the fingerprints of the user. In this way, the device recognises the fingerprints and allows the device to operate in an uninhibited manner. The authorised user experiences no impact on device usage. An unauthorised user, however, may not activate the device if their fingerprints are not recognised.

In this way, a valid user may have a full range of operational capabilities provided while an invalid user may have only a reduced subset or indeed no operational capabilities provided.

In accordance with some embodiments described herein, there is provided a method of providing an aerosol for inhalation by a user, the method comprising: providing an aerosol provision device having a housing with an outwardly facing surface, control circuitry for controlling an activation state of the aerosol provision device and a fingerprint scanner for detecting fingerprints of users, the fingerprint scanner having at least one region, the fingerprint scanner having a surface, wherein the surface of the fingerprint scanner has an area which is at least 40% of the area of the outwardly facing surface of the housing of the aerosol provision device in use, activating the fingerprint scanner; sending a signal to the control circuitry originating from the fingerprint scanner, the signal corresponding to the fingerprints of a user; updating, by the control circuitry, an activation state of the aerosol provision device according to the signal from the fingerprint scanner.

In accordance with some embodiments described herein, there is provided an aerosol provision system, for providing an aerosol for inhalation by a user, comprising: a housing having an outwardly facing surface, the outwardly facing surface having an area; control circuitry for controlling an activation state of the aerosol provision device; a fingerprint scanner for detecting fingerprints of users, located on the housing of the aerosol provision device; and, aerosol generating material located within the housing, the fingerprint scanner having at least one region, the fingerprint scanner having a surface, wherein the surface of the fingerprint scanner has an area which is at least 40% of the area of the outwardly facing surface of the housing of the aerosol provision device.

In accordance with some embodiments described herein, there is provided aerosol provision means for providing an aerosol for inhalation by a user, comprising: housing means having an outwardly facing surface, the outwardly facing surface having an area; control means for controlling an activation state of the aerosol provision means; and, fingerprint scanning means for detecting fingerprints of users, located on the housing of the aerosol provision means, the fingerprint scanning means having at least one region, the fingerprint scanning means having a surface, wherein the surface of the fingerprint scanning means has an area which is at least 40% of the area of the outwardly facing surface of the housing means of the aerosol provision means.

### DESCRIPTION OF DRAWINGS

The present teachings will now be described by way of example only with reference to the following figures:

FIG. 1 is a schematic view of an aerosol provision device according to an example;

FIG. 2 is a schematic view of an aerosol provision device according to an example;

FIG. 3 is a schematic view of an aerosol provision device according to an example; and,

FIG. 4 is a flow diagram according to an example.

While the invention is susceptible to various modifications and alternative forms, specific embodiments are shown by way of example in the drawings and are herein described in detail. It should be understood, however, that the drawings and detailed description of the specific embodiments are not intended to limit the invention to the particular forms disclosed. On the contrary, the invention covers all modifications, equivalents and alternatives falling within the scope of the present invention as defined by the appended claims.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

The present disclosure relates to aerosol provision systems, which may also be referred to as aerosol provision systems, such as e-cigarettes. Throughout the following description the term “e-cigarette” or “electronic cigarette” may sometimes be used, but it will be appreciated this term may be used interchangeably with aerosol provision system/device and electronic aerosol provision system/device. Furthermore, and as is common in the technical field, the terms “aerosol” and “vapour”, and related terms such as “vaporise”, “volatilise” and “aerosolise”, may generally be used interchangeably.

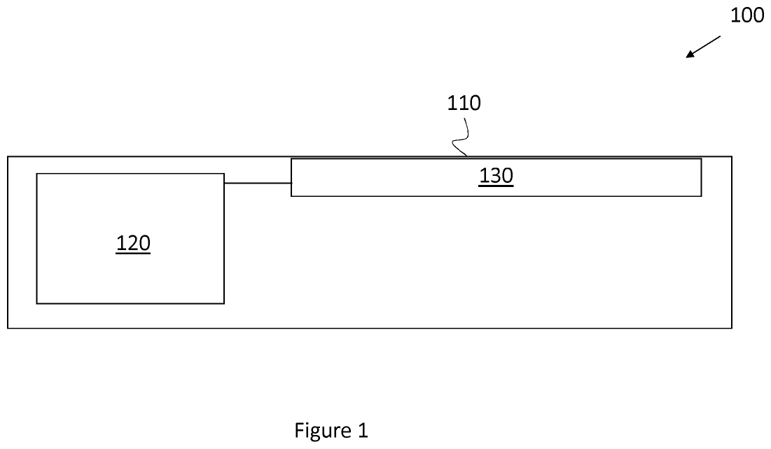

FIG. 1 illustrates a schematic view of an example of an aerosol provision device 100 according to the present invention. The aerosol provision device 100 has an aerosol provision device housing 110. The housing 110 has an outwardly facing surface, the outwardly facing surface having an area. The term outwardly facing takes a meaning herein of facing outward from the device 100. In practice, the surface that a user can see when interacting normally with the device 100 is the outwardly facing surface. This will have an area. This area is the area that the user's fingers may interact with during normal usage.

The aerosol provision device 100 has control circuitry 120. The control circuitry 120 is arranged to control an activation state of the aerosol provision device 100. The aerosol provision device 100 comprises a fingerprint scanner 130 for detecting fingerprints of users, located on the housing 110 of the aerosol provision device 100. The fingerprint scanner 140 has at least one region. The fingerprint scanner 140 has a surface. The surface of the fingerprint scanner 140 has an area which is at least 40% of the area of the outwardly facing surface of the housing 110 of the aerosol provision device 100. FIG. 1 shows the elements schematically and therefore, the size of the fingerprint scanner 140 is not to scale in FIG. 1.

In practice, this means that the fingerprint scanner 140 can obtain fingerprint readings from around 40% or more of the surface of the housing 110. The present arrangement identifies a user in the handling prior to use. For example, prior to use a user may remove the device 100 from a pocket or from a bag and move the device towards their mouth. In this time, fingerprints of the user will land on the fingerprint sensor 130. The sensor 130 is able to detect the fingerprints and send a signal to the control circuitry 120. The control circuitry 120 may compare the signals against a list of known fingerprints for authorised users. If the 10 signals correspond to a user that is authorised, the control circuitry 120 may operate the device 100 in a normal manner, i.e. where all functionality possible is available for the user should the user wish to use it.

The fingerprint scanner 130 shown in FIG. 1 has one region having a surface. The regions may be arranged on the device 100 in an arrangement that is thought to capture likely handling areas by the user. In particular, many users hold such devices between finger and thumb with additional fingers used for stability. The regions may arranged accordingly to capture such handling locations. In an example, one region may be on one side of the device 100 (say an upper side) and one region may be on another side of the device 100 (say a lower side). In this way, a user that located the thumb on a different side of the device 100 to fingers, may have both captured by the fingerprint scanner 130.

When “sides” are discussed herein, the discussion relates broadly to the facing direction of the surface. A number of aerosol provision device are cylindrical or the like in nature, so “sides” terminology is to be understood as a relating to portions of that single outwardly facing surface of the cylinder. There is no requirement for the device 100 to be of a particular cross section when viewed end-on.

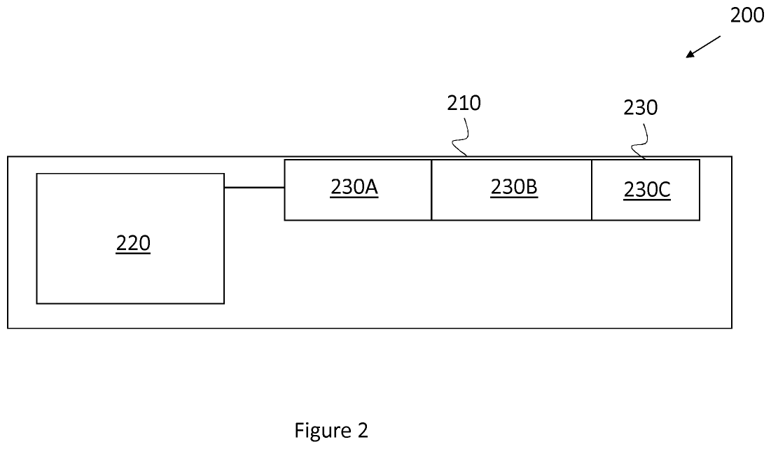

Referring now to FIG. 2, there is a shown a similar device 200 to the device 100 of FIG. 1. Similar features, to those features used in FIG. 1, are shown with the reference numerals increased by 100. For example, the device 100 of FIG. 1 is similar to the device 200 of FIG. 2. Similar or identical features may not be discussed for conciseness.

The device 200 of FIG. 2 has control circuitry 220 and fingerprint scanner 230. The fingerprint scanner 230 comprises a plurality of regions 230A, 230B, 230C. The regions 230A, 230B, 230C are adjacent one another to form the fingerprint scanner 230. The region 230B is shown to be larger (in FIG. 2) than region 230C. The regions 230A, 230B, 230C of the fingerprint scanner 230 may be arranged in different locations on the surface of the housing 210 of the device 200. This allows for good coverage of handling locations, where a user may grip the device 200 prior to or during use. At least one region may be spaced apart from at least one other region, each region having a surface summing to the surface of the fingerprint scanner.

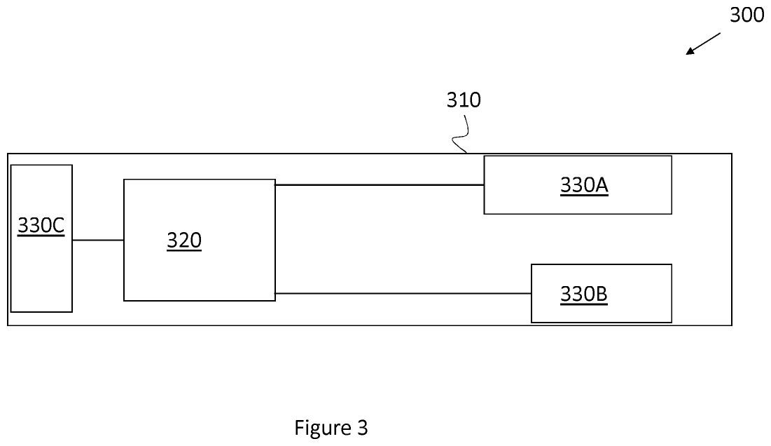

Referring now to FIG. 3, there is a shown a similar device 300 to the device 200 of FIG. 2. Similar features, to those features used in FIG. 2, are shown with the reference numerals increased by 100. For example, the device 200 of FIG. 2 is similar to the device 300 of FIG. 3. Similar or identical features may not be discussed for conciseness.

The device 300 of FIG. 3 has control circuitry 320 and fingerprint scanner 330 formed of regions 330A, 330B, 330C. The fingerprint scanner 330 comprises a plurality of regions 330A, 330B, 330C that are each spaced away from one another. The region 330A and other region 330B are arranged on opposite sides of the device 300. This has an effect that the regions 330A and 330B mainly face away from one another, with region 33A facing upward as shown in the figure while region 33B faces downward as in the figure. In this example, where a user grips the device on either side with finger and thumb, the device 300 may capture a fingerprint of a finger with e.g. region 330A and may capture a fingerprint of a thumb with e.g. region 330B.

The surface of the areas of each region 330A, 330B, 330C may sum to at least 40% of the area of the outwardly facing surface of the housing 310 of the device 300. In another example, the surface of the areas of each region 330A, 330B, 330C may sum to at least 20%, 25%, 30%, 35%, 45%, 50%, 55%, or 60% of the area of the outwardly facing surface of the housing 310 of the device 300. The surface areas of the regions may be around any of:
1.5 cm² to 3.5 cm² (which is suitable for use in a single fingerprint scanner);
3.0 cm² to 7.0 cm² (which is suitable for use in a double fingerprint scanner); and,
Up to 80 cm², for example 40 cm² to 80 cm² (which is suitable for use in a palm scanner).

The region 330A on the upward facing surface has a greater area than the region 330B on the lower facing surface, in the specific example shown in FIG. 3. The region 330C can be seen to be a different shape to the region 330A. There is no need for the regions to have the same dimensions or have the same shapes. For example, a region intending to capture the fingerprint of a thumb may be longer in one direction in comparison to a region intending to capture the fingerprint of one finger. A region intending to capture a fingerprint of a finger may be more circular than a region intending to capture a fingerprint of a thumb, which may be ovular or rectangular. Conversely, a region intending to capture a series of fingerprints from side by side fingers, may be longer in one dimension than a region intending to capture the fingerprint of a thumb.

In an example, the control circuitry 320 is arranged to selectively control activation of each of the plurality of regions 330A, 330B, 330C. In an example, the device 300 may be programmed to activate only those regions that are likely to obtain a signal from the authorised user. In particular, prior to use, the authorised user may hold the device 300 in a manner that is typical and comfortable for that user. The control circuitry 320 may activate all fingerprint scanner regions 330 and note which specific regions obtain a signal and what that signal is. In future uses, the control circuitry 320 may only activate those specific regions and compare the signal against the signal previously obtained. The regions are therefore separately activatable from one another.

In this way, the authorised user is easily recognised and the device uses less electrical power than in a system that activates all the regions of the fingerprint scanner every time. Furthermore, this decreases the likelihood of an unauthorised user using the device. The unauthorised user is not likely to hold the device in the precise same manner as the authorised user. Therefore, the device will note that there are missing signals from specific regions, furthermore the signals from those regions that are activated (if any) will not match the authorised user. In this way, a more robust system is provided than one with merely a fingerprint scanner without the arrangement as disclosed herein.

In a specific example the fingerprint scanner has 8 regions across the surface of the housing. The user is notified to hold the device in a manner that is comfortable. The device activates all fingerprint scanner regions and notes which provide a signal—this is a setup phase. The device also notes the signal. In the specific example, the user holds the device with three fingers and a thumb, this activates 4 regions. When the device is next used, the device activates those 4 regions and detects a signal from each. The device compares each signal to that obtained during the setup phase. Only if the signals match does the device enable use. This check and confirmation can occur over a very short time period, therefore the authorised user may experience no delay to their use of the device. An unauthorised user would need to mimic both how the user holds the device and the signals obtained by the scanners to access the device. This therefore provides a two fold security aspect that is more robust but does not impact the user's experience.

The authorised user may undergo several “setup phases” to record different comfortable ways of holding the device during use, each of which can be compared to the signals obtained directly prior to use. In this way, the user is not restricted to only one way of holding the device. In the example where regions are provided in an arrangement wherein some are adjacent and others are spaced apart, the device may activate those regions used in the setup phase as well as adjacent ones, to accommodate slight variations in the user's handling of the device. This improves the robustness of the process for the user, and reduces a negative impact of the present system on user experience.

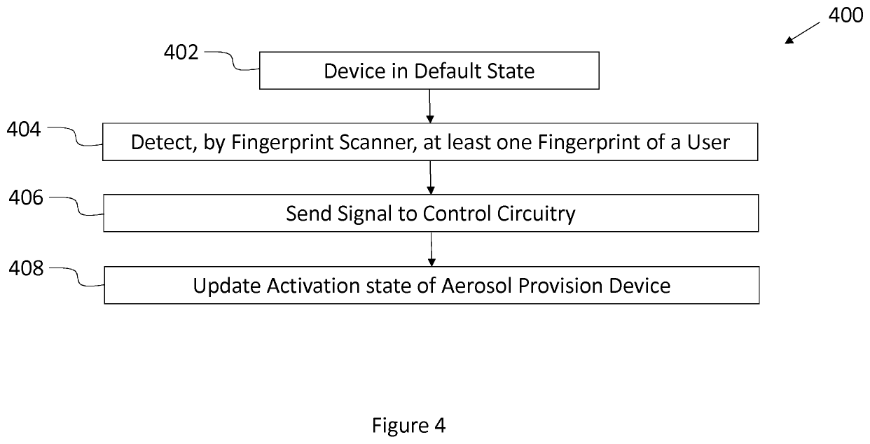

FIG. 4 shows a method 400 of use of an aerosol provision device. In the method 400, the device may start in a default state 402, which may be a non-operating state such that non-valid users cannot use the device. Alternatively, the default operating state may be a restricted operating state where only partial operation of the device is possible.

The present invention involves updating an activation sate of the aerosol provision device. In an “operating state”, elements of the aerosol provision device used to generate an aerosol (such as an atomiser, heater or the like) may be activated. The specific activation of the device may require an additional input which may be inhalation on the device by a user, pressing a button on the device or the like. Alternatively, the device may automatically generate aerosol by a heater in response to receiving a signal associated with a valid potential user from the fingerprint scanner. The control circuitry may receive such a signal from the relevant fingerprint scanner regions and send a signal to the heater arrangement or the like to provide an aerosol from an aerosol generating material that may be contained within, or separate to, the aerosol provision device.

The term “operating state” refers to a state in which the device may be used to provide an aerosol. When the aerosol provision device is combined with an aerosol generating material this is referred to herein as an aerosol provision system. The device can provide a large number of “operating states”. Different operating states may have different heating profiles (fast, slow, high temperature, low temperature, etc.) or different heating mechanisms (heater element, atomiser, vibrating plate, etc.). As such specific, operating states may dictate the performance of the system, such as selecting the heating mechanisms used and the heating profile used based on the identified user—one user may be able to store a preferred heating profile to be associated with their biometric data. In this way, in response to identification of user 1, corresponding heating mechanism 1 is offered to provide heating profile 1 on aerosol generating material. In response to identification of user 2, corresponding heating mechanism 2 may be offered to provide heating profile 2 on aerosol generating material. In this way, different users are provided a bespoke aerosol, in response to recognition of that user. This improves the ease of use, and the use experience, of a device for a user.

When a user intends to use the aerosol provision device, the device detects at least one fingerprint of the user 404. The device detects the fingerprint using a first region of the fingerprint scanner (as explained above). In the specific examples mentioned above, the device may detect a plurality of fingerprints of the user (including thumb or thumbs).

The fingerprint scanner then sends a signal to the control circuitry 406. The signal is compared by the control circuitry 406 to known authorised user data. This known authorised user data may have been obtained prior to use during a setup phase or the like. Setup may occur on purchase of the device or prior to use for the first time.

In step 408, there is an update of activation state of the aerosol provision device. This may take the form of updating the activation state to an operating state such as fully enabled for use, partially enabled for use or prevented from use. As discussed above, this change is based on the detected fingerprint signals from the user. These are used to ascertain whether the user is authorised or not.

As mentioned above, in an example, the fingerprint scanner comprises a plurality of regions. At least one region is spaced apart from at least one other region. In use, including the setup phase as discussed above, the fingerprint scanner is activated. Each region of the plurality of regions of the fingerprint scanner sends a signal to the control circuitry. The control circuitry notes each region of the plurality of regions providing a positive signal and each region of the plurality of regions providing a negative signal. A positive signal is a signal associated with a fingerprint and a negative signal is a signal not associated with a fingerprint. Then, in a second use, the control circuitry activates only each region of the plurality of regions that provided a positive signal in the first use. This saves battery life and increases the lifetime of the device while providing increase security in light of unauthorised users that would not hold the device in the same manner as the authorised user. This therefore increases the difficulty of hacking the device by an unauthorised user.

The devices and systems disclosed herein have a fingerprint scanner that obtains data from a user. This data may be processed by a number of components able to compare the data against a database (for example) of authorised users. This data may be analysed on-board the device by e.g. control circuitry. The control circuitry then analyses the signal and evaluates whether to allow or prevent use of the aerosol provision system or aerosol provision device. In another example, the data from the fingerprint scanner may be sent to a remote database or server for analysis. In such an example, the device or system may have a communications module for communicating with the remote database or server. The remote database or server may perform the analysis and provide a signal to the communications module. The signal ultimately sent to the control circuitry by the communication module may be one indicating the control circuitry should or should not allow use of the aerosol provision device or aerosol provision system. This allows for more complex analysis to be performed off the device, which may render the aerosol provision devices more cost efficient to produce.

The term “in response to” is used herein to indicate a second event (such as a signal or change of state of an aerosol provision device) that occurs subsequent to a first event. The second event may occur at a later time, after a predetermined time, or immediately after the first event.

The device and system herein are described as comprising several components that enable several advantages. The components may be disclosed as on-board the device or within the system. The components may be distributed and therefore not necessarily be located on-board the device. The functionality of the device can be provided by communicatively connected components, and such communication may be wireless, enabling such distribution. At which point it is reasonable to foresee that a distributed array of components will operate in the manner of the devices and systems disclosed herein. Components of the device or system may be contained in a further device such as a smartphone, computer, or remote server or the like.

This method provides a user-friendly user verification process that provides suitable protection against invalid users while not impeding use for valid users. The method offers a balance between overly strict and overly lenient access protection for the device. The user can alter the tolerance of any set of signals or fingerprint locations which can be accounted for by activating adjacent regions to those where fingerprints are detected during setup. A most lenient arrangement would result in the device activating all regions during any detection attempt. This reduces the requirement of the user to reproduce the hand position used during set up. The user can therefore personalise the level of strictness and security or leniency and ease of use as they prefer. This increases the overall user experience of the device.

The method and device disclosed herein enable protection over the use of the device without requiring an arduous authorisation process. This improves the user experience of the device and the safety of general use of the device.

In a particular example, the device disclosed herein may operate with a flavour pod which is replaceable in the device—this may be referred to as a consumable. The flavour may be any of tobacco and glycol and may include extracts (e.g., licorice, hydrangea, Japanese white bark magnolia leaf, chamomile, fenugreek, clove, menthol, Japanese mint, aniseed, cinnamon, herb, wintergreen, cherry, berry, peach, apple, Drambuie, bourbon, scotch, whiskey, spearmint, peppermint, lavender, cardamon, celery, cascarilla, nutmeg, sandalwood, bergamot, geranium, honey essence, rose oil, vanilla, lemon oil, orange oil, cassia, caraway, cognac, jasmine, ylang-ylang, sage, fennel, piment, ginger, anise, coriander, coffee, or a mint oil from any species of the genus Mentha), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof.

When combined with an aerosol generating medium, the aerosol provision device as disclosed herein may be referred to as an aerosol provision system.

Thus there has been described an aerosol provision device, for providing an aerosol provision device, for providing an aerosol for inhalation by a user, comprising: a housing having an outwardly facing surface, the outwardly facing surface having an area; control circuitry for controlling an activation state of the aerosol provision device; and, a fingerprint scanner for detecting fingerprints of users, located on the housing of the aerosol provision device, the fingerprint scanner having at least one region, the fingerprint scanner having a surface, wherein the surface of the fingerprint scanner has an area which is at least 40% of the area of the outwardly facing surface of the housing of the aerosol provision device.

The aerosol provision system may be used in a tobacco industry product, for example a non-combustible aerosol provision system.

In one embodiment, the tobacco industry product comprises one or more components of a non-combustible aerosol provision system, such as a heater and an aerosolizable substrate.

In one embodiment, the aerosol provision system is an electronic cigarette also known as a vaping device.

In one embodiment the electronic cigarette comprises a heater, a power supply capable of supplying power to the heater, an aerosolizable substrate such as a liquid or gel, a housing and optionally a mouthpiece.

In one embodiment the aerosolizable substrate is contained in or on a substrate container. In one embodiment the substrate container is combined with or comprises the heater.

In one embodiment, the tobacco industry product is a heating product which releases one or more compounds by heating, but not burning, a substrate material. The substrate material is an aerosolizable material which may be for example tobacco or other non-tobacco products, which may or may not contain nicotine. In one embodiment, the heating device product is a tobacco heating product.

In one embodiment, the heating product is an electronic device.

In one embodiment, the tobacco heating product comprises a heater, a power supply capable of supplying power to the heater, an aerosolizable substrate such as a solid or gel material.

In one embodiment the heating product is a non-electronic article.

In one embodiment the heating product comprises an aerosolizable substrate such as a solid or gel material, and a heat source which is capable of supplying heat energy to the aerosolizable substrate without any electronic means, such as by burning a combustion material, such as charcoal.

In one embodiment the heating product also comprises a filter capable of filtering the aerosol generated by heating the aerosolizable substrate.

In some embodiments the aerosolizable substrate material may comprise an aerosol or aerosol generating agent or a humectant, such as glycerol, propylene glycol, triacetin or diethylene glycol.

In one embodiment, the tobacco industry product is a hybrid system to generate aerosol by heating, but not burning, a combination of substrate materials. The substrate materials may comprise for example solid, liquid or gel which may or may not contain nicotine. In one embodiment, the hybrid system comprises a liquid or gel substrate and a solid substrate. The solid substrate may be for example tobacco or other non-tobacco products, which may or may not contain nicotine. In one embodiment, the hybrid system comprises a liquid or gel substrate and tobacco.

In order to address various issues and advance the art, the entirety of this disclosure shows by way of illustration various embodiments in which the claimed invention(s) may be practiced and provide for a superior electronic aerosol provision system. The advantages and features of the disclosure are of a representative sample of embodiments only, and are not exhaustive and/or exclusive. They are presented only to assist in understanding and teach the claimed features. It is to be understood that advantages, embodiments, examples, functions, features, structures, and/or other aspects of the disclosure are not to be considered limitations on the disclosure as defined by the claims or limitations on equivalents to the claims, and that other embodiments may be utilised and modifications may be made without departing from the scope and/or spirit of the disclosure. Various embodiments may suitably comprise, consist of, or consist essentially of, various combinations of the disclosed elements, components, features, parts, steps, means, etc. In addition, the disclosure includes other inventions not presently claimed, but which may be claimed in future.

1. An aerosol provision device, for providing an aerosol for inhalation by a user, comprising:
a housing having an outwardly facing surface, the outwardly facing surface having an area;
control circuitry for controlling an activation state of the aerosol provision device; and,
a fingerprint scanner for detecting fingerprints of users, located on the housing of the aerosol provision device,
the fingerprint scanner having at least one region, the fingerprint scanner having a surface, wherein the surface of the fingerprint scanner has an area which is at least 40% of the area of the outwardly facing surface of the housing of the aerosol provision device.

2. An aerosol provision device according to claim 2, wherein the fingerprint scanner comprises a plurality of regions, wherein at least one region is spaced apart from at least one other region, each region having a surface summing to the surface of the fingerprint scanner.

3. An aerosol provision device according to claim 2, wherein the surface of at least one region has a different area to the surface of at least one other region.

4. An aerosol provision device according to claim 2, wherein the surface of at least one region has a different shape to the surface of at least one other region.

5. An aerosol provision device according to claim 2, wherein the control circuitry is arranged to selectively control activation of each of the plurality of regions.

6. An aerosol provision device according to claim 1, wherein the outwardly facing surface of the housing comprises an upward facing portion and a downward facing portion, and
wherein at least one portion of the fingerprint scanner is arranged on the upward facing portion and at least one portion of the fingerprint scanner is arranged the downward facing portion.

7. An aerosol provision device according to claim 5, wherein the at least one portion of the fingerprint scanner arranged on the upward portion has a width that is narrower than the at least one portion of the fingerprint scanner arranged on the downward facing portion.

8. An aerosol provision device according to claim 1, wherein the surface of the fingerprint scanner is arranged on the outwardly facing surface of the housing so as to be located where a user holds the aerosol provision device.

9. An aerosol provision device according to claim 1, wherein the aerosol provision device comprises a communication module arranged to:
receive signals from the fingerprint scanner;
send signals to and receive signals from an external database;
send signals to the control circuitry,
wherein the signals sent to the external database correspond to signals received from the fingerprint scanner, and wherein the signals sent to the control circuitry correspond to the signals received from the external database.

10. An aerosol provision device according to any preceding claim, wherein the control circuitry is arranged to perform the method of claim 11.

11. A method of providing an aerosol for inhalation by a user, the method comprising:
providing an aerosol provision device having a housing with an outwardly facing surface, control circuitry for controlling an activation state of the aerosol provision device and a fingerprint scanner for detecting fingerprints of users, the fingerprint scanner having at least one region, the fingerprint scanner having a surface, wherein the surface of the fingerprint scanner has an area which is at least 40% of the area of the outwardly facing surface of the housing of the aerosol provision device
in use, activating the fingerprint scanner;
sending a signal to the control circuitry originating from the fingerprint scanner, the signal corresponding to the fingerprints of a user;
updating, by the control circuitry, an activation state of the aerosol provision device according to the signal from the fingerprint scanner.

12. A method of providing an aerosol for inhalation by a user according to claim 11, wherein the wherein the fingerprint scanner comprises a plurality of regions and wherein at least one region is spaced apart from at least one other region, the method further comprising:
in a first use, activating the fingerprint scanner;
sending, by each region of the plurality of regions of the fingerprint scanner, a signal to the control circuitry;
noting, by the control circuitry, each region of the plurality of regions providing a positive signal and each region of the plurality of regions providing a negative signal;
in a second use, activating only each region of the plurality of regions providing a positive signal in the first use,
wherein a positive signal is a signal associated with a fingerprint, and a negative signal is a signal not associated with a fingerprint.

13. A method of providing an aerosol for inhalation by a user according to claim 11, wherein sending a signal to the control circuitry originating from the fingerprint scanner comprises at least one of:
sending a signal direct to the control circuitry from the fingerprint scanner; and,
sending a signal from the fingerprint scanner to a communication module and subsequently sending a signal from the communication module to the control circuitry.

14. An aerosol provision system, for providing an aerosol for inhalation by a user, comprising:
a housing having an outwardly facing surface, the outwardly facing surface having an area;
control circuitry for controlling an activation state of the aerosol provision system;
a fingerprint scanner for detecting fingerprints of users, located on the housing of the aerosol provision system; and,
aerosol generating material located within the housing,
the fingerprint scanner having at least one region, the fingerprint scanner having a surface, wherein the surface of the fingerprint scanner has an area which is at least 40% of the area of the outwardly facing surface of the housing of the aerosol provision system.

15. An aerosol provision system according to claim 14, wherein the control circuitry is arranged within the housing.

16. An aerosol provision system according to claim 14, further comprising a communication module arranged to:
receive signals from the fingerprint scanner;
send signals to and receive signals from an external database;
send signals to the control circuitry,
wherein the signals sent to the external database correspond to signals received from the fingerprint scanner, and wherein the signals sent to the control circuitry correspond to the signals received from the external database.

17. An aerosol provision system according to claim 16, wherein the communication module is arranged within the housing.

18. (canceled)
